(19) United States
(12) Patent Application Publication
(10) Pub. No.: US 2025/0214568 A1
(43) Pub. Date: Jul. 3, 2025

(54) AUTONOMOUS VALET PARKING SYSTEM AND METHOD FOR OPERATING THE SAME

(71) Applicants: Hyundai Motor Company, Seoul (KR); Kia Corporation, Seoul (KR); Ajou University Industry-Academic Cooperation Foundation, Suwon-si (KR)

(72) Inventors: Jong Hyuck Lee, Hwaseong-Si Gyeonggi-Do (KR); Young Bin Min, Hwaseong-Si (KR); Bong Sob Song, Suwon-Si (KR)

(21) Appl. No.: 19/002,314

(22) Filed: Dec. 26, 2024

(30) Foreign Application Priority Data
Dec. 29, 2023 (KR) 10-2023-0196676

(51) Int. Cl. B60W 30/06; B60W 60/00; G01C 21/00

(52) U.S. Cl. CPC B60W 30/06; B60W 60/001; G01C 21/3811; B60W 2420/403; B60W 2552/53; B60W 2554/20; B60W 2555/60

(57) ABSTRACT

Disclosed is a method for generating a parking lot map, including: obtaining image information and positioning information indicating a position at which the image is captured; detecting a sign from the image information; extracting characteristics for distinguishing the sign from another sign; and incorporating information correlating a position of the sign obtained based on the positioning information in a digital map of a parking lot with characteristics of the sign into the digital map of the parking lot.

### CROSS REFERENCE TO RELATED APPLICATION

The present application claims priority to Korea Patent Application No. 10-2023-0196676, filed Dec. 29, 2023, the entire contents of which is incorporated herein for all purposes by this reference.

### FIELD

The present disclosure relates to a system which supports autonomous valet parking and a method for operating the same, more particularly, to a parking lot map generating system including position markers within a parking lot for autonomous valet parking and a method for operating the same.

### BACKGROUND

An autonomous valet parking system may refer to a system that autonomously (e.g., without a human driver is driving, for example, after a driver stops the vehicle and gets out of the vehicle in a drop-off area) moves a vehicle to an empty parking space in a parking lot and completes parking.

In addition, when the driver returns or requests the car be returned, the autonomous valet parking system may autonomously move the parked vehicle to a pick-up area, and allow the driver to take over the vehicle in the pick-up area.

In cooperation with a vehicle capable of the autonomous driving, the autonomous valet parking system may park a vehicle in an empty parking space.

In order for the autonomous valet parking system to control and allow the autonomous driving vehicle to travel to an empty parking space, the current position of the vehicle within the parking lot must be precisely identified. However, a GPS signal or the like may not be able to reach in a parking lot, and/or it may otherwise be difficult to precisely determine a position of the vehicle because some parking lots are configured with a plurality of floors.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for an autonomous valet parking system. A method for controlling autonomous parking of a vehicle using a digital map of a parking lot may comprise: receiving an image from within the parking lot and positioning information indicating a position at which the image was captured; detecting, via automatic object recognition of the image, a sign in the image; extracting, from the image of the sign, one or more characteristics of the sign for distinguishing the sign from another sign; incorporating information correlating the one or more characteristics with a position, of the sign based on the positioning information, into the digital map of the parking lot; generating, based on the digital map comprising the information, a guide route from the vehicle to an empty parking spot; and controlling, based on the guide route, the vehicle to park in the empty parking spot.

An autonomous parking server for controlling autonomous parking of a vehicle in a parking lot may comprise a communication interface and a processor. The processor may be configured to: receive, from the communication interface, an image from within the parking lot and positioning information indicating a position at which the image was captured, detect, via automatic object recognition of the image, a sign in the image, extract, from the image of the sign, one or more characteristics of the sign for distinguishing the sign from another sign; incorporate information correlating the one or more characteristics with a position, of the sign based on the positioning information, into a digital map of the parking lot; generate, based on the digital map comprising the information, a guide route from the vehicle to an empty parking spot; and control, based on the guide route, the vehicle to park in the empty parking spot.

These and other features and advantages are described in greater detail below.

### BRIEF DESCRIPTION OF THE DRAWINGS

These and other aspects, features, and advantages of the present disclosure will be more clearly understood from the following detailed description, taken in conjunction with the accompanying drawings, in which:

FIG. 1 shows an autonomous valet parking system according to an example of the present disclosure.

FIG. 2 is a block diagram of a vehicle according to various examples of the present disclosure.

FIG. 3 is a conceptual diagram for describing an autonomous valet parking system and a method for operating the same according to an example of the present disclosure.

FIG. 4 is a view illustrating an example of installing a marker in a parking lot.

FIG. 5 is a view illustrating examples of signs, words provided on a ground, or a symbol, a guidance board, or an advertisement board which may be seen in a parking lot.

FIG. 6 is a view illustrating a system configured to generate a digital map which includes a unique sign of a parking lot as a marker.

FIG. 7 is a flowchart illustrating a method for generating a digital map which includes a unique sign of a parking lot as a marker.

FIG. 8 is an example of recognizing position information of a vehicle by using a sign and a marker together.

FIG. 9 is an example illustrating a case of which a sign is changed.

### DETAILED DESCRIPTION

Hereinafter, examples of the present disclosure will be described in further detail with reference to the accompanying drawings.

The configuration and advantages of the present disclosure will be more apparent from the following detailed description. Wherever possible, the same reference numerals will be used throughout the drawings to refer to the same elements even if shown in another drawing. It will be paid attention that detailed description of known arts will be omitted if it is determined that the arts can mislead the present disclosure.

Before describing the present disclosure in detail, terms being used in the present disclosure may be defined as below.

The vehicle may be equipped with an autonomous driving system (ADS) and may be a vehicle capable of autonomous driving. For example, via the ADS, the vehicle may perform at least one among steering, acceleration, deceleration, lane change, and stopping (or short stop) without a driver's manipulation. For example, the ADS may include at least one among Pedestrian Detection and Collision Mitigation System (PDCMS), Lane Change Decision Aid System (LCDAS), Land Departure Warning System (LDWS), Adaptive Cruise Control (ACC), Lane Keeping Assistance System (LKAS), Road Boundary Departure Prevention System (RBDPS), Curve Speed Warning System (CSWS), Forward Vehicle Collision Warning System (FVCWS), and Low Speed Following (LSF).

A driver may be a human being. The driver may be a driver of the vehicle having an autonomous driving system.

A vehicle controller (e.g., vehicle controller device and/or computing device) may be a device configured to control at least one component of the vehicle and/or at least one function of the vehicle. At least one function of the vehicle may include, for example, at least one among steering, acceleration, deceleration (or braking), lane change, lane detection, lateral control, obstacle recognition and distance detection, powertrain control, safe area detection, engine on/off, power on/off, and vehicle lock/unlock. The listed functions of the vehicle are merely examples for helping understanding, and examples of the present disclosure are not limited thereto.

The vehicle herein may have a function of performing autonomous valet parking and/or be configured to receive instructions to perform autonomous valet parking.

An autonomous valet parking server may monitor one or more vehicles present in an infrastructure (e.g., a parking facility), determine, for a vehicle that enters the infrastructure (e.g., the parking facility), a guide route to move the vehicle to a parking space (a target position), determine a permitted driving area, instruct autonomous driving of the vehicle by transmitting a control command to the vehicle, and transmit an emergency stop command in case of emergency so as to stop the vehicle.

The infrastructure may be a parking facility. At least one sensor may be disposed in the infrastructure (e.g., parking facility). In addition, the infrastructure may include a parking gate. According to an example, the infrastructure may comprise a parking facility, at least one sensor, and an autonomous valet parking server.

A target position may refer to an empty parking space (e.g., a space to park a vehicle without a vehicle parked therein). The target position may also, alternatively, refer to an area in which the driver can get in the vehicle (e.g., in a situation in which the vehicle is going to exit the parking lot and/or a pick-up area where the driver can retrieve the vehicle).

The guide route may refer to a route by which the vehicle can pass so as to reach the target position. For example, in a situation in which parking is performed, it is a route from the drop-off area to an empty parking space. For example, the guide route may take the form of one or more instructions, such as ‘go forward by 50 m’, ‘turn to the left 90° at a corner’, and the like.

A driving route may refer to a route along which the vehicle can be instructed to follow.

The permitted driving area may refer to an area in which driving is permitted in the parking lot. The permitted driving area may comprise the driving route and/or the driving route may be determined to be within the permitted driving area. The permitted driving area may be defined with a partition, parked vehicles and/or moving vehicles, and/or parking lines.

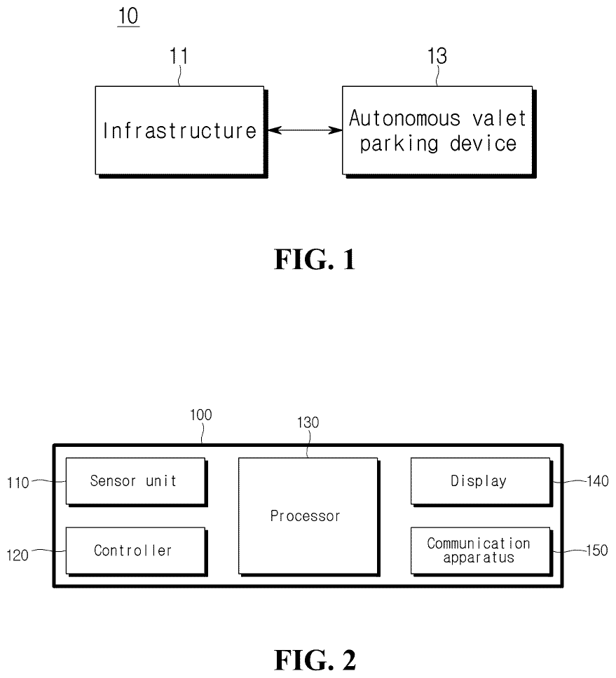

FIG. 1 shows an autonomous valet parking system according to an example of the present disclosure.

Referring to FIG. 1, the autonomous valet parking system 10 may include an infrastructure 11, and an autonomous valet parking device 13.

The infrastructure 11 may refer to a device or a system of devices for operating, managing, and performing the autonomous valet parking. For example, the infrastructure 11 may comprise and/or operate in a parking facility. According to an example, the infrastructure 11 may also, or alternatively, include one or more sensors (e.g., installed at a parking facility) and a server/computing device configured to control the vehicle and/or a device for controlling the vehicle. The infrastructure may also, or alternatively, comprise a communication apparatus, an alarm, and/or a display device/user interface. The server may further be configured to control/communicate with the communication apparatus, the alarm, and/or the display device/user interface. Also, or alternatively, the infrastructure 11 may include a parking gate. For example, the server may be an autonomous valet parking server configured to control a vehicle.

The autonomous valet parking device 13 may refer to a vehicle configured to perform the autonomous valet parking. According to an example, the autonomous valet device 13 may comprise a component (e.g., computing device and/or part thereof) or a group of components included in a vehicle capable of performing the autonomous valet parking (e.g., capable of performing autonomous driving and of receiving.

FIG. 2 is a block diagram of a vehicle according to various examples of the present disclosure.

The configuration of the vehicle illustrated in FIG. 2 is one example, and each component may be configured as one chip, one component, or one electronic circuit, or a combination of chips, components, and/or electronic circuits. According to the example, some of the components illustrated in FIG. 2 may be divided into a plurality of components and/or configured as different chips, different components, and/or different electronic circuits. Some components may be combined to form one chip, one component, or one electronic circuit. According to the example, some of the components illustrated in FIG. 2 may be omitted or other components not illustrated may be added. At least some of the components of FIG. 2 will be described with reference to subsequent drawings.

Referring to FIG. 2, a vehicle 100 may include a sensor unit 110, a controller 120, a processor 130, a display 140, and a communication apparatus 150.

The sensor unit 110 (e.g., comprising at least one sensor) may sense (e.g., via the at least one sensor) a surrounding environment of the vehicle 100. The sensor unit 110 may generate data related to the surrounding environment based on the sensed result (sensed surrounding environment). For example, the sensor unit 110 may obtain information on objects around the vehicle (for example, other vehicle, a person, an object, a curb, a guardrail, a lane, an obstacle, etc.) based on the sensed data obtained from the at least one sensor. Information on the object around the vehicle may include, for example, at least one among a position of the object, a size of the object, a shape of the object, a distance to the object, and/or a relative speed of the object. As another example, the sensor unit 110 may measure a position of the vehicle 100 using at least one sensor. The sensor unit 110 may include, for example, at least one sensor selected among a camera, a light detection and ranging (LIDAR) sensor, a radio detection and ranging (RADAR) sensor, an ultrasonic sensor, an infrared sensor, and/or a position measurement sensor. The listed sensors are merely examples for helping understanding, and the sensors included in the sensor unit 110 of the present disclosure are not limited thereto.

According to the example, a camera may generate image data which includes an object positioned in front, at a rear and on a side of the vehicle 100, by capturing image around the vehicle. According to the example, the lidar may generate information on an object positioned in front, on a rear side and/or on a side of the vehicle 100 using light (or laser). According to the example, the radar may generate information on an object positioned in front, on a rear side and/or on a side of the vehicle 100 using electromagnetic waves (or radio waves). According to the example, the ultrasonic sensor may generate information on an object positioned in front, on a rear side and/or on a side of the vehicle 100 using ultrasonic waves. According to the example, the infrared sensor may use infrared rays to generate information about an object positioned in front, to a rear and/or to a side of the vehicle 100.

According to the example, the position measurement sensor may measure the current position of the vehicle 100. The position measurement sensor may include at least one among a Global Positioning System (GPS) sensor, a Differential Global Positioning System (DGPS) sensor and/or a Global Navigation Satellite System (GNSS) sensor. The position measurement sensor may generate position data of the vehicle based on a signal generated by at least one among a GPS sensor, DGPS sensor and GNSS sensor.

The controller 120, according to the control of the processor 130, may control operation of at least one component of the vehicle 100 and/or at least one function of the vehicle. The at least one function may be, for example, at least one among a steering function, an acceleration function (and/or a longitudinal acceleration function), a deceleration function (and/or a longitudinal deceleration function, a brake function), a lane change function, a lane detection function, an obstacle recognition and a distance detection function, a lateral control function, a powertrain control function, a safety zone detection function, an engine on/off, a power on/off, and/or a vehicle lock/unlock function.

According to the example, the controller 120, according to the control of the processor 130, may control at least one component of the vehicle and/or at least one function of the vehicle for autonomous driving of the vehicle 100. For example, for the autonomous driving, the controller 120 may control the operation of at least one function among a steering function, an acceleration function, a deceleration function, a lane change function, a lane detection function, a lateral control function, an obstacle recognition and/or distance detection function, a powertrain control function, and/or a safe zone detection function.

The display 140 may display information related to the vehicle 100. For example, the display 140 may display/output various information related to the state of the vehicle 100 to the driver of the vehicle 100 under the control of the processor 130. The various information related to the state of the vehicle may include at least one among information representing whether various components included in the vehicle and/or at least one function of the vehicle are normally operated, and/or information representing the driving state of the vehicle. However, in a case of performing the autonomous valet parking without the driver, the display 140 may be in an off-state in which information is not displayed/output.

The communication apparatus 150 may send and/or receive data with the infrastructure 11. The communication may be referred to as a vehicle-to-infrastructure (V2I) communication. The communication apparatus 150 may send data to and/or receive data from the other vehicle. The communication may be referred to as a vehicle-to-vehicle (V2V) communication. The V2I communication and/or the V2V communication may be collectively referred to as a vehicle-to-everything (V2X) communication. The communication apparatus 150 may receive data (for example, a target position, a guide route, or a command, etc.) transmitted from the infrastructure 11 (e.g., form the server of the infrastructure 11). The communication apparatus 150 may process the received data and/or send the processed data to the processor 130. The communication apparatus 150 may transmit data generated by the vehicle 100 to the infrastructure 11. The communication apparatus 150 may send data to and/or receive data from a terminal of the driver of the vehicle 100.

The communication apparatus 150 may receive and/or send data by using a wireless communication protocol and/or a wired communication protocol. Examples of a wireless communication protocol may include wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared data association (IrDA), Ultra-Wideband (UWB), Zigbee, near field communication (NFC), ultra sound communication (USC), visible light communication (VLC), Wi-Fi, and Wi-Fi Direct. In addition, examples of the wired communication protocol may include wired local area network (LAN), wired wide area network (WAN), power line communication (PLC), USB communication, Ethernet, serial communication, an optical/coaxial cable, and the like, but are not limited thereto, and any and all protocol which can provide an environment for communication with the other devices may be included.

The processor 130 may control the overall operation of the vehicle 100. According to the example, the processor 130 may include an electrical control unit (ECU) capable of integrally controlling components in the vehicle 100. For example, the processor 130 may include a central processing unit (CPU) and/or a micro processing unit (MCU) capable of performing arithmetic processing.

The processor 130 may control the controller 120 based on the data received via the sensor unit 110 and/or the communication apparatus 150. The processor 130 may generate a control signal for controlling the vehicle 100 according to the data received from the infrastructure 11, and send the generated control signal to the controller 120.

The processor 130 may mean a device capable of controlling the vehicle 100, and performing a series of operations or determinations for performing the autonomous valet parking. For example, the processor 130 may be a part of the autonomous valet parking device 13 in which programs including instructions for performing the autonomous valet parking is executed.

As a part of the autonomous valet parking device 13, the processor 130 may control the autonomous driving such that the vehicle 100 can be parked at a target position in the parking lot in cooperation with the infrastructure 11. The processor 130 may provide the controller 120 with a command so that the controller 120 can perform the autonomous driving.

The processor 130 may control the vehicle to be moved according to the guide route based on guide route information received from the infrastructure 11.

In the above-described FIG. 2, the controller 120 and the processor 130 have been described as each separate component, however, the controller 120 and the processor 130 may be integrated into one component.

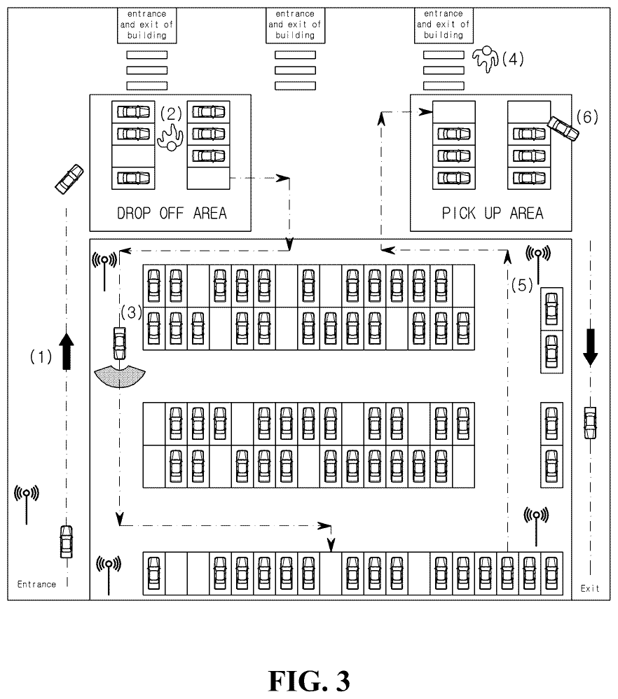

FIG. 3 is a conceptual diagram for describing the autonomous valet parking system and a method for operating the same according to an example of the present disclosure.

Referring to FIG. 3, at (1), the vehicle 100 may be driven (e.g., by a driver and/or autonomously) to enter the parking lot and/or to the drop-off area.

At (2), the vehicle 100 may be stopped in/delivered to the drop off area and the vehicle controller may be configured to communicate with/receive commands from and/or be controlled by the infrastructure (e.g., the driver may park the vehicle 100 in the drop-off area, get out of the vehicle 100, and/or allow/enable the vehicle 100 controller to be accessed by/communicate with the infrastructure 11).

At (3), the infrastructure 11 (e.g., the autonomous valet parking server included in the infrastructure 11) may search for an empty parking space among a plurality of parking spaces present in the parking lot, and/or determine a proper parking space (e.g., a target position) for the vehicle to be parked. The infrastructure 11 may also, or alternatively, determine a guide route to the determined target position. The vehicle 100 may autonomously travel based on the guide route and/or via the control of the infrastructure 11. The vehicle 100 performs the autonomous valet parking at the target position after reaching around the target position.

At (4), the driver may recall the vehicle 100 (e.g., determine the vehicle should exit the parking lot and request the vehicle 100 be moved to the pick-up area).

At (5), the infrastructure 11 (e.g., the autonomous valet parking server included in the infrastructure 11) may determine a proper target position. For example, the proper target position may be an empty parking space among a plurality of parking spaces present in the pick-up area. Also, or alternatively, the infrastructure 11 (e.g., the autonomous valet parking server may determine a guide route to the determined target position). The vehicle 100 may travel based on the guide route according to the control of the infrastructure 11 and/or autonomously. The vehicle 100 may perform autonomous valet parking to park at the target position after/based on reaching the target position.

At (6), the vehicle 100 may be returned to the driver and/or control of the driver and/or other external control to the infrastructure 11 (e.g., the driver may reach the pick-up area, regain control of the vehicle driving controller for the vehicle 100 back from the infrastructure 11, and drive the vehicle to move to the exit of the parking lot).

As illustrated in FIG. 3, the vehicle 100 and/or the infrastructure 11 must have a map of the parking lot so as to determine a guide route and/or travel along the guide route according to the control of the infrastructure 11 and/or autonomously. The vehicle 100 and/or the infrastructure 11 must identify a position of the vehicle 100 in the map, and/or recognize whether the vehicle 11 travels accurately along the guide route. To this end, the vehicle 100 may capture images of the surroundings using a sensor comprising a camera, and/or recognize its position based on the captured image.

A marker may be used to locate the vehicle 100 within the parking lot. The marker may comprise a physical sign comprising/indicating a unique identification (ID), which can be detected by the vehicle 100 (e.g., a camera of the vehicle 100) and/or may be installed in the parking lot, so as to support the position verification of the vehicle 100.

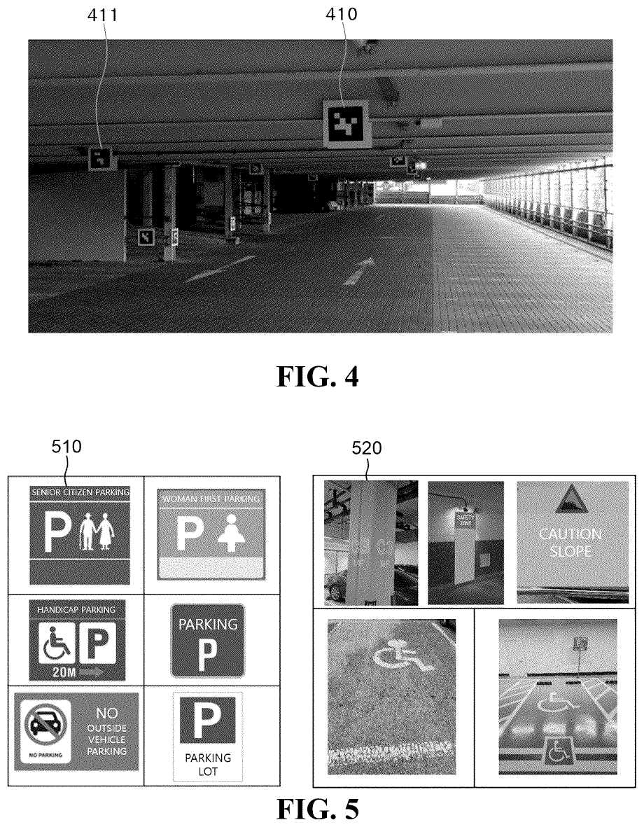

FIG. 4 is a view illustrating an example of installing the marker in the parking lot.

As illustrated in FIG. 4, it is possible to identify an accurate position in the parking lot by installing markers 410 and 411, which include unique IDs (e.g., unique and/or distinguishable within the parking lot and/or within a region of the parking lot), at certain positions which can be detected by the vehicle 100, and allowing the vehicle 100 to recognize the marker and to extract the unique ID so as to figure out a position corresponding to the unique ID in the digital map.

However, as illustrated in FIG. 4, the markers 410 and 411 must be coded to include unique ID information like a QR code, and installed at preset certain positions. That is, the markers 410 and 411 may be manufactured and/or installed in a way to perform a unique function of a marker.

Signs which are already installed in the parking lot, such as signs mandated to be installed in the parking lot, words provided on a ground, or a symbol, a guidance board, or an advertisement board, may also, or alternatively, be used as markers.

FIG. 5 is a view illustrating examples of signs, words provided on a ground, or a symbol, a guidance board, or an advertisement board which may be seen in a parking lot.

As illustrated in FIG. 5, various signs (e.g., 510 and 520) may be provided in the parking lot. Each sign may include a different symbol and/or character, and may be sufficiently mutually distinguishable (e.g., in context of the parking lot) to identify a particular location in the parking lot. As such, by obtaining (e.g., imaging and/or recognizing by image recognition) and distinguishing signs which are already provided in the parking lot, it is possible to use them as the marker for positioning. In the signs which are set for positioning, IDs may be specified.

If using the signs already provided in the parking lot as the markers, it may be necessary to identify characteristics to distinguish signs from each other (e.g., in place of dedicated position markers) and corresponding positions of the signs in advance, and to incorporate the characteristics and/or image of the signs and the corresponding positions into the digital map of the parking lot.

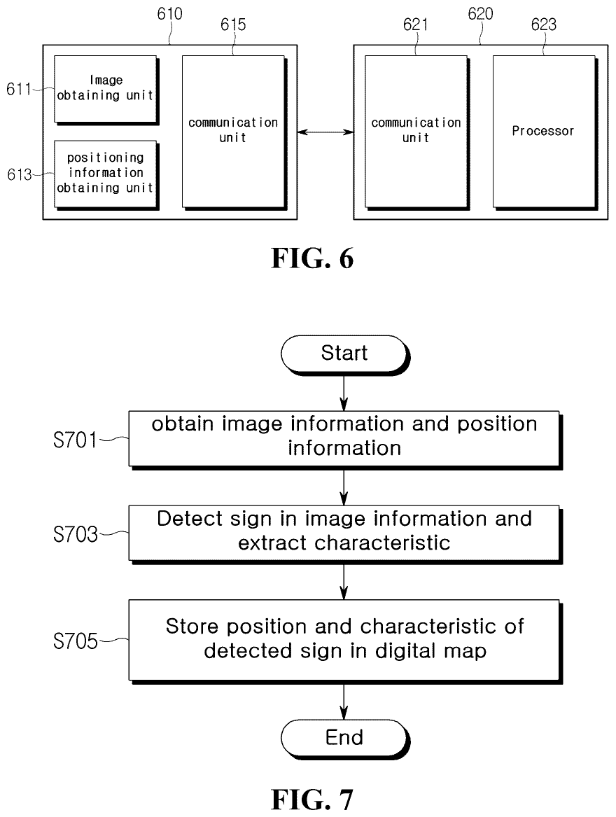

FIG. 6 is a view illustrating a system configured to generate a digital map which includes a unique sign of a parking lot as a marker, and FIG. 7 is a flowchart illustrating a method for generating a digital map which includes a unique sign of a parking lot as a marker.

Referring to FIGS. 6 and 7, a sign obtaining device 610 may include an image obtaining unit 611 (e.g., a camera), a positioning information obtaining unit 613, and a communication unit 615 (e.g., interface). A digital map generating device 620 may include a communication unit 621 (e.g., interface) and a processor 623.

The sign obtaining device 610 may comprise a vehicle and/or a computing device of a vehicle, and/or a device which is temporarily provided in the vehicle and is configured to use (e.g., is configured to connect with and/or communicate with) sensors attached to the vehicle. The sign obtaining device 610 may comprise an autonomous driving robot, which may be other than and/or differ from the vehicle, and/or may comprise a smart device such as a smart mobile phone which is carried and moved by an operator.

The digital map generating device 620 may be the autonomous valet parking server, or may be a different device from the autonomous valet parking server according to another example. According to another example, the digital map generating device 620 may the autonomous valet parking server, or a computer program executable in a general computing device.

For convenience, FIG. 7 is described by way of an example in which the steps are performed by a processor circuit. One, some, or all steps of the example method of FIG. 7, or portions thereof, may be performed by one or more other circuits. One or some, steps of the example method of FIG. 7 may be omitted, performed in other orders, and/or otherwise modified, and/or one or more additional steps may be added.

Referring to FIGS. 6 and 7, in an operation S701, the sign obtaining device 610 may obtain images of inside the parking lot from the image obtaining unit 611. The positioning information obtaining unit 613 (e.g., at the same time) may obtain position information of positions at which each image is obtained and/or to which each image corresponds. The image obtaining unit 611 may comprise a camera provided in the vehicle and/or a mobile phone or other device mounted in/on the vehicle. The positioning information obtaining unit 613 may comprise a GPS system/device, according to the example, however, according to another example, the positioning information obtaining unit 613 may be a separate positioning measuring device capable of accurately measuring a position at which a sign is provided using a facility provided for precise positioning.

The sign obtaining device 610 may send the obtained image information and the positioning information to the digital map generating device 620 through the communication unit 615.

In an operation S703, the digital map generating device 720 may detect signs from the image information received via the communication unit 621 and/or extract characteristics of each sign. The digital map generating device 620 may recognize a sign, a guidance board, a word(s), and/or a symbol(s) shown in at least a portion of the image and/or in the entire image and detect signs.

The sign may include symbolic information such as the symbols for the disabled shown in the signs and on the ground, identification number marked on a wall or a column for identifying a parked surface, notices in various shapes and containing various contents, and the like.

The digital map generating device 620 may detect signs and then, extract characteristics corresponding to each sign. The characteristics corresponding to each sign may include kinds of signs, components contained in the signs, colors included in the signs, and relative position information of the components of the sign from one another, but are not limited thereto. The components may include Korean characters, English characters, symbols, and the like.

The digital map generating device 620 may extract at least one characteristic of characteristics related to: information and/or a position of an English character, information and/or a position of a Korean character, and/or information and/or a position of a symbol, each of which are included in each symbol.

Considering an example of a sign 510 in FIG. 5, the digital map generating device 620 may detect the sign 510 from the image, and/or may extract information (e.g., which character, a font, a color, a size, etc.) and/or a position of a Korean character and/or information and a position of a symbol from the detected sign 510. The digital map generating device 620 may extract a characteristic that words “Elderly First Parking Section” are provided on an upper end of the sign 510. Also, or alternatively, the digital map generating device 620 may extract a characteristic that a symbol ‘P’ and a symbol indicating the elderly is provided side by side on a center of the sign 510 in a big size.

Considering an example of an identification number 520 of the parking surface in FIG. 5, the digital map generating device 620 may detect the identification number 520 of a parked surface from the image and obtain information and a position of an English character from the detected identification number 520. The digital map generating device 620 may extract the identification number of the parked surface, which are “C3” “MF”, from the image, and extract information that “C3” and “MF” are positioned vertically parallel to each other. Also, or alternatively, a characteristic that “C3” is provided in a bigger size than that of “MF” may be extracted as well.

According to the example, the above-described detection of the sign, and characteristics extraction of each sign may be performed based on the artificial intelligence.

In an operation S705, the digital map generating device 620 may correlate positions of signs detected in each image in the digital map and characteristics of the signs based on positioning information of each image obtained from the sign obtaining device 610 through the communication unit 621, and incorporate them into the digital map. According to the example, the digital map generating device 620 may indicate a symbol representing the detected sign at a position corresponding to the positioning information in the digital map. In addition, the digital map generating device 620 may incorporate, into the digital map, the information of which a position corresponding to the positioning information in the digital map and characteristics of the detected signs are matched to each other.

Position information based on the signs may be used additionally in the digital map. Existing parking lots may already have markers to inform position information installed therein, and the digital map may have the markers and/or position information correlated with each other stored therein. Therefore, the vehicle may obtain position information of the vehicle based on the marker. However, due to the limiting conditions of installing the markers, markers may not be installed in every needed position inside the parking lot. In such a case, it is possible to replace the signs at the needed positions with the markers, and/or additionally use markers, which may raise the accuracy of the position information by using the signs.

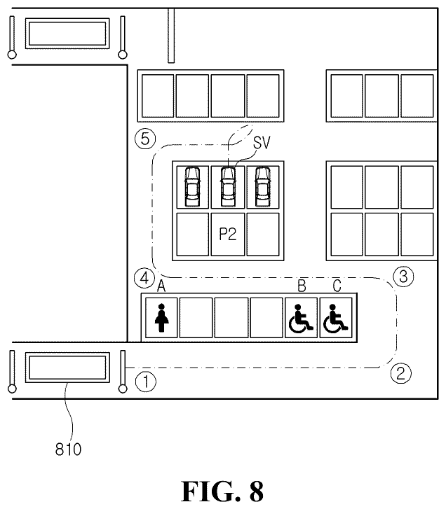

FIG. 8 is an example of recognizing position information of a vehicle by using the sign and the marker together.

Referring to FIG. 8, there may be a plurality of markers, inside the parking lot and/or imageable form inside the parking lot, illustrated solely as an example as five markers indicated in FIGS. 8 as \textcircled{1}, \textcircled{2}, \textcircled{3}, \textcircled{4}, and \textcircled{5}. The sign obtaining device 610 and/or the digital map generating device 620 may detect signs A, B, and C in the parking lot, and/or may store the sign information in the digital map by correlating the signs to the position information.

If a new sign is recognized in an image, and a marker exists nearby, or another sign is registered nearby, the digital map generating device 620 may not add the new sign to the digital map. For example, a sign A in FIG. 8 is disposed at a position similar to the marker 4, and the sign A may not be necessary in obtaining the position information of the vehicle. Therefore, the digital map generating device 620 may not incorporate the position information of the sign A into the digital map.

Similarly, the digital map generating device 620 may already have obtained position information of the sign B and have contained the position information thereof in the digital map. If sign C then recognized in an image, given that sign C is disposed at a position similar to the sign B, the sign C may not be necessary/particularly useful in obtaining the position information of the vehicle. Accordingly, the digital map generating device 620 may not include position information of the sign C into the digital map.

Referring to FIG. 8, the vehicle may be parked at the drop-off area 810 (e.g., by the driver). Thereafter, the vehicle may be autonomously driven by (e.g., based on instructions/commands from) the infrastructure 11 (e.g., via the autonomous valet parking server) to proceed to a target position P2.

If the vehicle is autonomously driven based the control of the autonomous valet parking server, the autonomous valet parking server may provide the vehicle with the guide route and/or instruct the vehicle to autonomously travel by itself, and/or may provide the vehicle with a series of control commands based on the guide route.

The autonomous valet parking server (and/or the vehicle, if traveling autonomously based on the guide route) may detect a marker and/or a sign disposed at a position the vehicle passes. The detected marker and/or sign may be used to determine/confirm whether the vehicle is travelling along the guide route and/or may obtain the position information of the vehicle. For example, upon recognizing the marker \textcircled{1} while controlling the autonomous driving so as to park the vehicle, the autonomous valet parking server (and/or the vehicle) may recognize that the vehicle performs autonomous driving after leaving the drop-off area 810. Also, or alternatively, if the autonomous valet parking server recognizes that the markers \textcircled{2} and \textcircled{3} are detected, the autonomous valet parking server may recognize that the vehicle is successfully proceeding along the guide route. Also, or alternatively, the autonomous valet parking server may recognize that the vehicle moves precisely along the guide route to the target position P2 as the sign B, and the markers \textcircled{4} and \textcircled{5} are recognized. Also, or alternatively, if \textcircled{1}, \textcircled{2}, \textcircled{3}, \textcircled{4} and/or \textcircled{5}, and/or any other expected signs are not recognized/detected, and/or recognized/detected in a wrong order (an order incongruous with following the guide route), corrective controls/instructions may be provided to the vehicle to return to the route.

According to another example, the sign information may be updated in real-time.

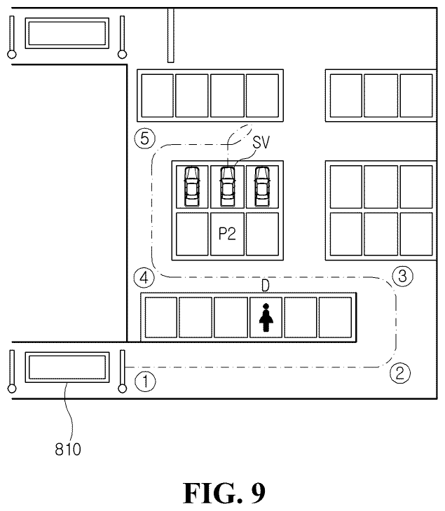

FIG. 9 is an example illustrating a case of which a sign is changed.

Relative to FIG. 8, in FIG. 9, the sign A, the sign B, and the sign C are not present, and a sign D is added. The autonomous driving vehicle may obtain images while traveling along the guide route for parking, and may transmit the images to the autonomous valet parking server. A server provided for the autonomous valet parking and/or, the digital map generating device 620 may detect that the previously existing signs A, B, and C disappeared and a new sign D appeared. The digital map generating device 620 may recognize that the sign A, the sign B, or the sign C is not detected from the image captured by the autonomous driving vehicle, and/or may determine that the signs have been removed. According to another example, if the corresponding signs are not detected from the images obtained from a plurality of vehicles, the digital map generating device 620 may determine that the signs are removed. As such, if determined that the signs, which were used as the markers for position detection, have been removed, the digital map generating device 620 may remove the sign information and the position information from the digital map.

The digital map generating device 620 may recognize that the sign D is newly detected from the images captured by the autonomous driving vehicle, determine whether to use the new sign D as a marker for position detection, and if the new sign D is determined to be used as the marker for position detection, the sign D may be correlated with the characteristic thereof and the position information and may be stored in the digital map.

The digital map generating device 620 may update information of the markers and signs for position detection incorporated in the existing digital map based on the image information obtained from the vehicle which travels for parking.

As described above, the present disclosure has proposed a method for using various signs which are already installed or indicated in the site, instead of using markers which requires additional manufacture and installation in the site for the purpose of identifying position information of a vehicle in a parking lot.

In addition, when a marker is already installed in the parking lot, use of various signs provided in the parking lot may improve preciseness in obtaining position information of a vehicle.

In order for the autonomous valet parking system to precisely guide the autonomous driving vehicle to a parking space, it is necessary to precisely figure out a position of the vehicle within a map of the parking lot.

Therefore, various examples of the present disclosure disclose a method for figuring out a precise position of a vehicle within a map of a parking lot, and a method for generating a digital map facilitating to figure out a precise position of the vehicle.

The technical problem to be achieved by the present disclosure is not limited to the above-mentioned technical problem, and other technical problems that are not mentioned will be clearly understood by ordinary-skilled persons in the art to which the present disclosure pertains from the following description.

One example is a method for generating a digital map of a parking lot. The method includes obtaining image information and positioning information indicating a position at which the image is captured, detecting a sign from the image information, extracting characteristics for distinguishing the sign from another sign and incorporating information correlating a position of the sign obtained based on the positioning information with characteristics of the sign into the digital map of the parking lot.

Another example is a parking lot digital map generating device including a communication unit and a processor. Further, the processor may obtain image information of the parking lot and positioning information indicating a position at which the image is captured through the communication unit, detect a sign from the image information and incorporate information correlating a position of the sign obtained based on the positioning information with characteristics of the sign into the digital map of the parking lot.

According to various examples of the present disclosure, it is possible to facilitate the autonomous valet parking system to perform the autonomous valet parking easily and without any error by precisely figuring out a position of the autonomous driving vehicle within the parking lot.

In one or more exemplary examples, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

When the examples are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

Described herein are examples of the disclosure. It is, of course, not possible to describe every conceivable combination of components or methodologies of the disclosed concepts via the examples, but one of ordinary skill in the art will recognize that many combinations and permutations of the examples herein are possible. Accordingly, the described examples are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution.

For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method for controlling autonomous parking of a vehicle using a digital map of a parking lot, comprising:
receiving an image from within the parking lot and positioning information indicating a position at which the image was captured;
detecting, via automatic object recognition of the image, a sign in the image;
extracting, from the image of the sign, one or more characteristics of the sign for distinguishing the sign from another sign;
incorporating information correlating the one or more characteristics with a position, of the sign based on the positioning information, into the digital map of the parking lot;
generating, based on the digital map comprising the information, a guide route from the vehicle to an empty parking spot; and
controlling, based on the guide route, the vehicle to park in the empty parking spot.

2. The method of claim 1,
wherein the sign comprises at least one of:
a signboard installed in the parking lot,
one or more words or symbol provided on a ground,
a guidance board, or
an advertisement board.

3. The method of claim 2,
wherein the one or more characteristics of the sign comprises at least one of:
a kind of the sign,
one or more components contained in the sign,
one or more colors included in the sign, or
relative position information of the components of the sign relative to each other.

4. The method of claim 3,
wherein the one or more components comprise one or more of characters or symbols, and
wherein the extracting the one or more characteristics comprises at least one of:
extracting characters information and relative position information of the characters; or
extracting symbol information and relative position information of the symbol.

5. The method of claim 4,
wherein the detecting the sign from the image and the extracting the one or more characteristics are performed via an artificial intelligence model.

6. The method of claim 1,
wherein the incorporating the information into the digital map comprises modifying the digital map to indicate symbols representing a kind of the sign at the position of the sign in the digital map.

7. The method of claim 6,
wherein the incorporating the information into the digital map of the parking lot is based on determining the position of the sign is at least a preset distance from a marker or another sign previously incorporated into the digital map.

8. The method of claim 1, further comprising:
based on receiving, from the vehicle following the guide route, an image indicating a new sign, comparing the new sign to information associated with a previous sign incorporated into the digital map of the parking lot; and
based on the comparing indicating the new sign is not consistent with the previous sign, updating the digital map to incorporate new information correlating one or more characteristics of the new sign with a position of the new sign.

9. The method of claim 8, wherein the digital map comprises information associated with a previous sign; and
wherein the updating the digital map further comprises removing, based on images, from a plurality of vehicles following a plurality of guide routes, not indicating the previous sign, the information associated with the previous sign.

10. The method of claim 8,
wherein the updating the digital map to incorporate the new information is further based on the new sign being detected in a plurality of images received from a plurality of vehicles.

11. An autonomous parking server for controlling autonomous parking of a vehicle in a parking lot, the autonomous parking server comprising:
a communication interface; and
a processor, wherein the processor is configured to:
receive, from the communication interface, an image from within the parking lot and positioning information indicating a position at which the image was captured,
detect, via automatic object recognition of the image, a sign in the image,
extract, from the image of the sign, one or more characteristics of the sign for distinguishing the sign from another sign;
incorporate information correlating the one or more characteristics with a position, of the sign based on the positioning information, into a digital map of the parking lot;
generate, based on the digital map comprising the information, a guide route from the vehicle to an empty parking spot; and
control, based on the guide route, the vehicle to park in the empty parking spot.

12. The autonomous parking server of claim 11,
wherein the sign comprises at least one of:
a signboard installed in the parking lot,
one or more words or symbol provided on a ground,
a guidance board, or
an advertisement board.

13. The autonomous parking server of claim 12,
wherein the one or more characteristics of the sign comprises at least one of:
a kind of the sign,
one or more components contained in the sign,
one or more colors included in the sign, or
relative position information of the components of the sign relative to each other.

14. The autonomous parking server of claim 13,
wherein the one or more components comprise one or more of characters or symbols, and
wherein the processor is further configured to perform at least one of:
extracting characters information and relative position information of the characters; or
extracting symbol information and relative position information of the symbol.

15. The autonomous parking server of claim 14,
wherein the processor is further configured to use an artificial intelligence model to:
detect the sign in the image; and
extract the one or more characteristics.

16. The autonomous parking server of claim 11,
wherein the processor is further configured to indicate symbols representing a kind of the sign at the position in the digital map.

17. The autonomous parking server of claim 16,
wherein the processor is further configured to incorporate the sign into the digital map based on the position of the sign being at least a preset distance from a marker or a position of another sign previously incorporated into the digital map.

18. The autonomous parking server of claim 11, wherein the processor is further configured to:
based on receiving, from the vehicle following the guide route, an image indicating a new sign, compare the new sign to information associated with a previous sign incorporated into the digital map; and
based on the comparing indicating the new sign is not consistent with the previous sign, update the digital map to incorporate new information correlating one or more characteristics of the new sign with a position of the new sign.

19. The autonomous parking server of claim 18,
wherein the processor is further configured to remove, based on images, from a plurality of vehicles following a plurality of guide routes, not indicating the previous sign, the information associated with the previous sign.

20. The autonomous parking server of claim 18,
wherein the processor is further configured to incorporate the new information based on the new sign being detected in a plurality of images received from a plurality of vehicles.
